(19) United States
(12) Patent Application Publication
(10) Pub. No.: US 2011/0073666 A1
(43) Pub. Date: Mar. 31, 2011

(54) BOILER SYSTEM HAVING DUAL HEATING WATER TANKS

(76) Inventor: Sa-Yun Jang, Seongnam-si (KR)

(21) Appl. No.: 12/994,352

(22) PCT Filed: May 26, 2009
(86) PCT No.: PCT/KR2009/002768

§ 371 Date: Nov. 23, 2010

(30) Foreign Application Priority Data
May 26, 2008 (KR) 10-2008-0048455

(51) Int. Cl. G05D 23/185

(52) U.S. Cl. 236/12.11

(57) ABSTRACT

The present invention relates to a boiler system with dual hot water tanks. More specifically, the invention provides a boiler system with dual hot water tanks wherein one boiler comprises high-temperature and low-temperature water tanks. The invention mixes high-temperature water in the high-temperature tank with low-temperature water in the low-temperature tank at different flow rates in a mixing valve, and supplies hot water at a preset temperature to a water supply heat exchanger so the temperature of the heated water in the water supply heat exchanger is constantly maintained. The present invention can supply hot water at a constant temperature always suitable for use and is free from inconvenience or discomfort caused by thermal deviation, because hot water at a temperature higher or lower than the preset temperature is mixed with the preset-temperature water, and then supplied to the water supply heat exchanger.

### TECHNICAL FIELD

The present invention relates, in general, to a boiler system with dual hot water tanks and, more particularly, to a boiler system with dual hot water tanks, in which high-temperature water in a high-temperature tank is mixed with low-temperature water in a low-temperature tank to supply hot water at a preset temperature to a feedwater heat exchanger, thus always keeping the temperature of the heated water constant.

### BACKGROUND ART

Generally, as shown in FIG. 1, a boiler system is constructed so that heating water heated in a boiler 1 is stored in a thermal storage tank 10 having excellent thermo-keeping capacity, and is supplied to a heating pipe 20 of a room or a feedwater heat exchanger 30, thus heating the room or water.

The boiler system is provided with one boiler 1 and one thermal storage tank 10, and is constructed so that, when a temperature T0 of thermal storage water supplied from the thermal storage tank to the heating pipe 20 or the feedwater heat exchanger 30 is lower than a preset temperature of heating water, the boiler is operated to reheat the water, and then the water is fed through the thermal storage tank to the heating pipe 20 or the feedwater heat exchanger 30.

However, the conventional boiler system is problematic in that, even when the temperature T0 of the thermal storage water supplied from the thermal storage tank 10 to the heating pipe 20 or the feedwater heat exchanger 30 is higher than a preset temperature of heating water, the water is supplied without the temperature being controlled, so that a room may be excessively heated above a preset temperature or the temperature T2 of hot water may become excessively high.

Especially, the conventional boiler system is problematic in that heating water supplied through the thermal storage tank 10 does not stay at a constant temperature, so that hot water discharged from the feedwater heat exchanger 30 may momentarily cause a user displeasure and discomfort because of the slight change in the temperature of the hot water.

### DISCLOSURE

### Technical Problem

Accordingly, the present invention has been made keeping in mind the above problems occurring in the prior art, and an object of the present invention is to provide a boiler system with dual hot water tanks, in which one boiler is accompanied by a high-temperature water tank and a low-temperature water tank, and high-temperature water in the high-temperature water tank and low-temperature water in the low-temperature water tank are mixed at different flow rates by a mixing valve, so that hot water of a preset temperature is supplied to a feedwater heat exchanger, thus keeping the temperature of water heated in the feedwater heat exchanger constant.

### Technical Solution

In order to accomplish the above object, the present invention provides a boiler system with dual hot water tanks, constructed to supply hot water of a boiler to a heating pipe or a feedwater heat exchanger to discharge heated water of a predetermined temperature, the boiler system including a high-temperature water tank storing hot water which is heated in the boiler, a low-temperature water tank storing hot water which is received from the feedwater heat exchanger or the heating pipe and supplying the hot water to the boiler, and a mixing valve mixing the hot water supplied from the high-temperature water tank with the hot water supplied from the low-temperature water tank so as to supply mixed hot water of a predetermined temperature to the feedwater heat exchanger, wherein the mixing valve controls a flow rate of the hot water of the low-temperature water tank which is to be mixed, depending on a temperature of the hot water of the high-temperature water tank, thus supplying the mixed hot water of the predetermined temperature.

### ADVANTAGEOUS EFFECTS

According to the present invention, a boiler system with dual hot water tanks is advantageous in that high-temperature hot water higher than a preset temperature and low-temperature hot water lower than a preset temperature are mixed with each other to provide hot water of a preset temperature, and the hot water of the preset temperature is supplied to a feedwater heat exchanger, thus being capable of always supplying hot water at a temperature which is proper to use, and preventing the temperature of hot water from changing when the hot water is in use so that a user does not feel displeasure or discomfort.

### DESCRIPTION OF DRAWINGS

FIG. 1 is a view illustrating the construction of a conventional boiler system;

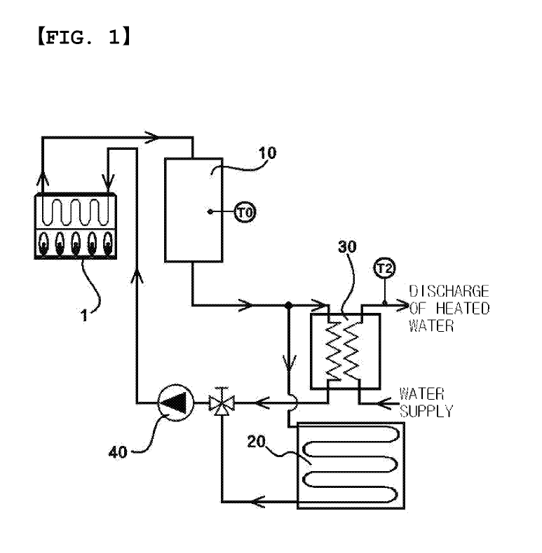

FIG. 2 is a view illustrating the construction of a boiler system with dual hot water tanks according to the present invention; and

FIG. 3 is a view illustrating the construction of a mixing valve of the boiler system with the dual hot water tanks according to the present invention.

### MODE FOR INVENTION

Hereinafter, the preferred embodiment of the present invention will be described in detail with reference to the accompanying drawings.

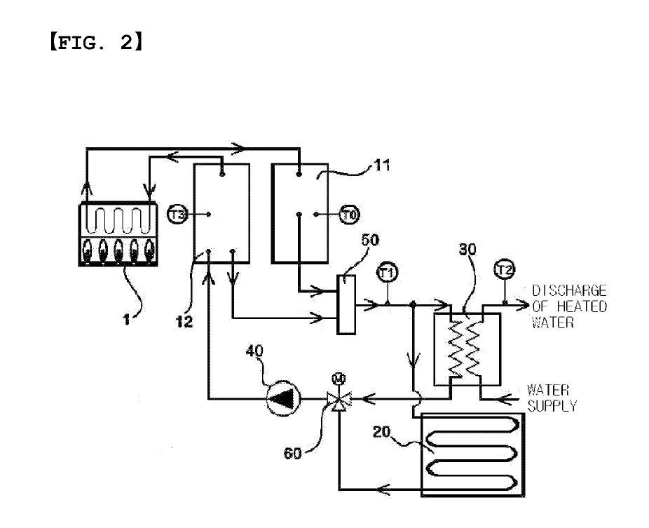

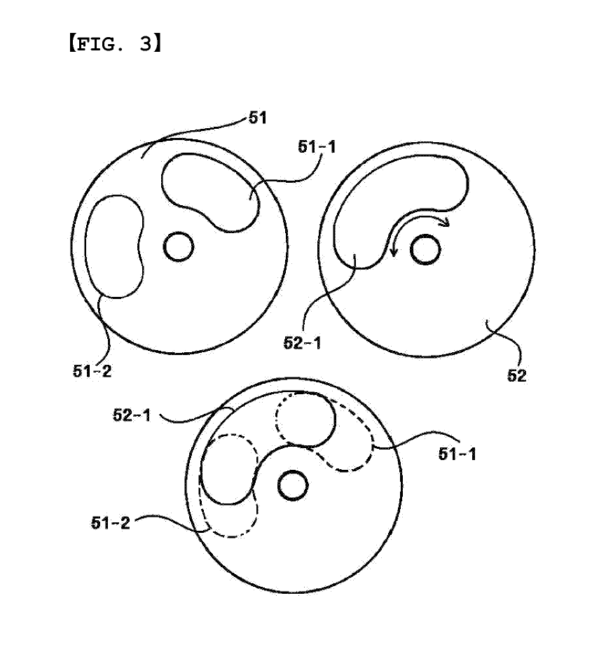

FIG. 2 is a view illustrating the construction of a boiler system with dual hot water tanks according to the present invention, and FIG. 3 is a view illustrating the construction of a mixing valve of the boiler system with the dual hot water tanks according to the present invention.

As shown in FIG. 2, a boiler system according to an embodiment of the present invention includes a high-temperature water tank 11 which stores hot water heated by and supplied from a boiler 1, a low-temperature water tank 12 which stores hot water received from a feedwater heat exchanger 30 or a heating pipe 20, and a mixing valve 50 which mixes hot water supplied from the high-temperature water tank with hot water supplied from the low-temperature water tank so as to supply hot water at a predetermined temperature to the feedwater heat exchanger 30 or the heating pipe 20.

Here, the high-temperature water tank 11 stores hot water heated by the boiler 1, and is constructed such that the stored hot water stays at a temperature T0 of 60 to 80° C.

The low-temperature water tank 12 stores low-temperature hot water which passes through the feedwater heat exchanger 30 or the heating pipe 20 and then is returned, and is constructed such that the low-temperature hot water stays at a temperature T3 of 55° C. or less. The low-temperature hot water is re-supplied to the boiler 1 or supplied to the mixing valve 50.

Further, since the low-temperature water of the low-temperature water tank 12 supplied to the mixing valve 50 is used to lower the temperature of the high-temperature water, supplied from the high-temperature water tank 11, to a preset temperature T1 of mixed hot water, wherein less of the low-temperature water is used than is the high-temperature water at the time when the low-temperature water is mixed with the high-temperature water.

As shown in FIG. 3, the mixing valve 50 includes a supply valve disc 51 and a discharge valve disc 52. The supply valve disc 51 that is fixed is provided with a high-temperature water supply port 51-1 and a low-temperature water supply port 51-2, each of which has the shape of a kidney. The discharge valve disc that is rotatable is provided with a discharge port 52-1 which has the same shape as the high-temperature water supply port 51-1 and the low-temperature water supply port 51-2, namely, the shape of a kidney.

Thus, when the high-temperature water of the high-temperature water tank 11 flows through the high-temperature water supply port 51-1 into the mixing valve 50 and the low-temperature water of the low-temperature water tank 12 flows through the low-temperature water supply port 51-2 into the mixing valve 50, a predetermined amount of hot water is discharged through the discharge port 52-1 of the discharge valve disc 52, so that the high-temperature water is mixed with the low-temperature water. As the discharge valve disc is rotated, the discharge port overlaps the high-temperature water supply port 51-1 and the low-temperature water supply port 51-2. The supply amount of the high-temperature water and the low-temperature water vanes depending on the overlapping area of the discharge port and the high-temperature and low-temperature water supply ports.

As for the low-temperature water tank 12, if the temperature T0 of the high-temperature water in the high-temperature water tank 11 is lower than the temperature T1 of the mixed hot water, the low-temperature water is discharged to the boiler 1 and then is re-heated. In contrast, if the temperature T0 of the high-temperature water is higher than the temperature T1 of the mixed hot water, the low-temperature water is supplied to the mixing valve 50.

Further, the mixing valve 50 is constructed so that it receives the high-temperature water of the temperature T0 and the low-temperature water of the temperature T3 from the high-temperature water tank 11 and the low-temperature water tank 12, respectively, and mixes the high-temperature water and the low-temperature water so that the mixed hot water has the temperature T1, and then supplies the mixed hot water to the feedwater heat exchanger 30 or the heating pipe 20.

For example, if a temperature T2 of hot water supplied from the feedwater heat exchanger 30 is set to be 55° C., and the boiler 1 is set to start operating when the temperature T0 of the high-temperature water is 60° C. and stop operating when the temperature T0 of the high-temperature water is 80° C., the temperature T0 of the high-temperature water in the high-temperature water tank 11 is maintained within the range of 60 to 80° C., and the temperature T3 of low-temperature water in the low-temperature water tank 12 is maintained at 55° C. or less.

The high-temperature water of 60 to 80° C. is mixed with the low-temperature water of 55° C. or less by the mixing valve 50, thus supplying mixed hot water having the temperature T1 of 55 to 60° C.

In other words, assuming that the capacity of the boiler 1 is 24,000 Kcal·H, water of 15° C. is supplied from the feedwater heat exchanger 30 at the flow rate of 10 LPM, and hot water of 55° C. is discharged, the quantity of heat required for 60 minutes is as follows: flow rate×change in temperature×time=10 LPM×40° C.×60 minutes=24,000 Kcal·H.

Here, when the flow rate of the mixed hot water supplied from the mixing valve 50 is 20 LPM, the temperature T1 of the mixed hot water is 60° C., and the temperature T3 at which the mixed hot water passes through the feedwater heat exchanger 30 and is returned to the low-temperature water tank 12 is 40° C., the quantity of heat supplied to the feedwater heat exchanger for 60 minutes is calculated as follows. That is, flow rate×change in temperature×time=20 LPM×20° C.×60 minutes=24,000 Kcal·H. It can be seen from this equation that the quantity of heat supplied to the feedwater heat exchanger is equal to the quantity of heat required when heating water and supplying hot water.

To this end, the boiler 1 supplies 24,000 Kcal·H corresponding to the capacity of the boiler to heat the low-temperature water of 40° C. such that it is changed into the high-temperature water of 60 to 80° C.

Here, if the flow rate of water of 15° C. which is supplied from the feedwater heat exchanger 30 at the flow rate of 10 LPM is reduced to 5 LPM, the water of 5 LPM is heated with the heat quantity of 24,000 Kcal·H. Thus, water is momentarily heated at 55° C. or more and supplied. However, according to the present invention, the heat quantity supplied to the feedwater heat exchanger can be controlled to be reduced to a proper heat quantity, that is, flow rate×change in temperature×time=5 LPM×40° C.×60 minutes=12,000 Kcal·H.

In other words, if the flow rate of supplied water is reduced and the temperature T2 of heated water is increased to a preset temperature or more, the temperature T1 of the mixed hot water is lowered in the mixing valve 50. When the discharge valve disc 52 is rotated so that the discharge port 52-1 moves to the low-temperature water supply port 51-2 of the supply valve disc 51, the inflow amount of the low-temperature water of the low-temperature water tank 12 is increased, and the supply amount of the high-temperature water of the high-temperature water tank 11 is reduced, thus reducing the temperature T1 of the mixed hot water.

Therefore, while the flow rate of the low-temperature water supplied from the low-temperature water tank 12 to the mixing valve 50 is increased, the flow rate of the low-temperature water supplied to the boiler 1 is reduced. Simultaneously, while the flow rate of the high-temperature water supplied from the high-temperature water tank 11 to the mixing valve is reduced, the temperature T0 of the high-temperature water is increased. Thereby, the heat quantity supplied from the boiler is reduced from 24,000 Kcal·H to 12,000 Kcal·H, namely, by 50%.

Further, if the flow rate of the water of 15° C. supplied to the feedwater heat exchanger 30 is reduced to 2 LPM, the heat quantity of 4,800 Kcal·H is required to obtain the heated water of 55° C. Thus, a boiler 1 having a capacity of 24,000 Kcal·H is controlled to be operated only at 20% capacity.

In the case where the operating range of a burner of the boiler 1 is variable and is continuously operated at 40%˜100% of capacity, if the operating rate of the boiler is reduced to 20% of the capacity as described above, it deviates from the variable range of the burner, thus triggering the On/Off operation.

When hot water stops being used, the discharge valve disc 52 is rotated in the mixing valve 50 so that the discharge port 52-1 is moved to the low-temperature water supply port 51-2 of the supply valve disc 51. Thereby, the inflow amount of the low-temperature water of the low-temperature water tank 12 is increased, and the supply amount of the high-temperature water of the high-temperature water tank 11 is reduced in proportion to the increased inflow amount, so that the temperature T1 of the mixed hot water is controlled to be lowered up to 55° C. Since the heat quantity is never lost while the mixed hot water passes through the feedwater heat exchanger 30 and returns to the low-temperature water tank 12, the temperature T3 of the low-temperature water of the low-temperature water tank is abruptly increased up to 55° C. In this case, the operation of the boiler 1 is immediately halted.

In brief, the present invention controls the supply flow rate when the low-temperature water of the low-temperature water tank having relatively irregular temperature T3 is supplied to the mixing valve 50, so that the temperature T1 of mixed hot water can be rapidly and precisely controlled to a preset temperature, thus always keeping the temperature T2 of hot water discharged from the feedwater heat exchanger 30 constant.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention is applied to a boiler system, thus always supplying hot water at a temperature which is proper to use, and preventing the temperature of hot water from changing when the hot water is in use so that a user does not feel displeasure or discomfort, therefore having high industrial applicability.

1. A boiler system with dual hot water tanks, constructed to supply hot water of a boiler (1) to a heating pipe (20) or a feedwater heat exchanger (30) to discharge heated water of a predetermined temperature, the boiler system comprising:
a high-temperature water tank (11) storing hot water which is heated in the boiler (1);
a low-temperature water tank (12) storing hot water which is received from the feedwater heat exchanger (30) or the heating pipe (20), and supplying the hot water to the boiler (1); and
a mixing valve (50) mixing the hot water supplied from the high-temperature water tank (11) with the hot water supplied from the low-temperature water tank (12) so as to supply mixed hot water of a predetermined temperature to the feedwater heat exchanger (30),
wherein the mixing valve (50) controls a flow rate of the hot water of the low-temperature water tank (12) which is to be mixed, depending on a temperature of the hot water of the high-temperature water tank (11), thus supplying the mixed hot water of the predetermined temperature.

2. The boiler system according to claim 1, wherein the mixing valve (50) comprises:
a supply valve disc (51) including a high-temperature water supply port (51-1) and a low-temperature water supply port (51-2), each of which has a shape of a kidney; and
a discharge valve disc (52) including a kidney-shaped discharge port (52-1),
wherein, as the discharge valve disc (52) is rotated according to a temperature (T2) of the heated water, a flow rate of each of the high-temperature water and the low-temperature water supplied through the discharge port (52-1) is regulated, thus controlling a temperature (T1) of the mixed hot water.

3. The boiler system according to claim 1, wherein the mixing valve (50) is constructed so that, when the temperature (T2) of the heated water is increased, the discharge valve disc (52) is rotated so that the discharge port (52-1) moves to the low-temperature water supply port (51-2), thus reducing the temperature (T1) of the mixed hot water, and when the temperature (T2) of the heated water is reduced, the discharge valve disc (52) is rotated so that the discharge port (52-1) moves to the high-temperature water supply port (51-1), thus increasing the temperature (T1) of the mixed hot water.

4. The boiler system according to claim 2, wherein the mixing valve (50) is constructed so that, when the temperature (T2) of the heated water is increased, the discharge valve disc (52) is rotated so that the discharge port (52-1) moves to the low-temperature water supply port (51-2), thus reducing the temperature (T1) of the mixed hot water, and when the temperature (T2) of the heated water is reduced, the discharge valve disc (52) is rotated so that the discharge port (52-1) moves to the high-temperature water supply port (51-1), thus increasing the temperature (T1) of the mixed hot water.
